(19) United States
(12) Patent Application Publication
(10) Pub. No.: US 2025/0170812 A1
(43) Pub. Date: May 29, 2025

(54) ELECTRICALLY FUNCTIONAL CELLULOSE-BASED SHEET, METHODS OF PRODUCTION THEREOF, AND APPLICATIONS THEREOF

(71) Applicant: Rodolphe KOEHLY, Montréal (CA)

(72) Inventor: Rodolphe KOEHLY, Montréal (CA)

(21) Appl. No.: 18/867,062

(22) PCT Filed: May 23, 2023
(86) PCT No.: PCT/CA2023/050703

§ 371 Date: Nov. 19, 2024

(30) Foreign Application Priority Data
May 20, 2022 (CA) 3159514
May 20, 2022 (FR) FR2204816

(51) Int. Cl. B32B 29/00; H01B 1/20

(52) U.S. Cl. CPC B32B 29/002; H01B 1/20; B32B 2255/12; B32B 2264/303; B32B 2307/202

(57) ABSTRACT

An electrically functional cellulose-based sheet is provided. The electrically functional cellulose-based sheet comprises a cellulose-based substrate layer comprising conductive microparticles, wherein one or both of the top surface or bottom surface of the substrate layer is partially or fully covered with a binder layer comprising conductive particles. A method of producing said electrically functional cellulose-based sheet is also provided, as well as applications for said electrically functional cellulose-based sheet.

### FIELD OF THE INVENTION

The present invention relates to the field of electrically functional cellulose-based sheets, as well as methods of production thereof and applications thereof, such as applications in the field of electronics, FSRs (Force-Sensing Resistors, or Force-Sensitive Resistors) and Contact Sensors.

### BACKGROUND OF THE INVENTION

The technology of FSR (Force-Sensing Resistors, or Force-Sensitive Resistors) was invented and patented in 1977 by Franklin Eventoff, who founded Interlink Electronics in 1985, a company based on his technology. In 2001, Eventoff founded a new company, Sensitronics, which has become a leader in developing force-sensing resistor technology worldwide. FSRs generally comprises a conductive polymer, which changes resistance in a predictable manner following application of force to its surface. The sensing film consists of both electrically conducting and non-conducting particles suspended in a matrix. Applying a force to the surface of the sensing film causes particles to touch the conducting electrodes, changing the resistance of the film. Force-sensing resistors are commonly used to create pressure sensing «buttons» and have applications in many fields, including musical instruments, medical equipment, car occupancy sensors, and portable electronics. Two technologies exist nowadays: The Shunt mode and the Thru mode. Both use lots of polymers such as oil-based polymers that are polluting and non-recyclable, and lots of metal, mainly silver, which is expensive. A design was patented by Tekscan with materials other than paper, producing electrically-sensitive materials with carbon-black pigments and sensitive inks as the sensitive elements, and combined with carbon-black and silver pigments in elastic polymers such as PET; the drawback of such materials is that they cannot be recycled, as polymers insulate pigments, which makes them hard to separate.

### SUMMARY OF THE INVENTION

According to the present invention, there is provided an electrically functional cellulose-based sheet comprising: a cellulose-based substrate layer comprising conductive microparticles and a top surface and a bottom surface, wherein one or both of the top surface or bottom surface is partially or fully covered with a binder layer comprising conductive particles.

In embodiments, there is provided an assembly comprising two single coated functional cellulose-based sheets.

In embodiments, there is provided a method of producing the electrically functional cellulose-based sheet.

In embodiments, there is provided an electrical component comprising the electrically functional cellulose-based sheet.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

FIG. 1 (a) is a front view of an electrically functional cellulose-based sheet according to an embodiment of the present invention. FIG. 1 (b) is an isometric view of the electrically functional cellulose-based sheet of FIG. 1(a).

FIG. 2 (a) is a front view of an electrically functional cellulose-based sheet according to another embodiment of the present invention. FIG. 2 (b) is an isometric view of the electrically functional cellulose-based sheet of FIG. 2(a).

FIG. 3 (a) is a front view of an electrically functional cellulose-based sheet according to another embodiment of the present invention. FIG. 3 (b) is an isometric view of the electrically functional cellulose-based sheet of FIG. 3(a).

FIG. 4 (a) is an isometric view of the electrically functional cellulose-based sheet of FIG. 2(b). FIG. 4 (b) is an isometric view of two of the electrically functional cellulose-based sheets of FIG. 1(b).

FIG. 5 (a) is an isometric view of the electrically functional cellulose-based sheet of FIG. 3(b). FIG. 5 (b) is an isometric view of two of the electrically functional cellulose-based sheets of FIG. 1(b).

FIG. 6 is a top view of an electrical component including an electrically functional cellulose-based sheet according to an embodiment of the present invention.

### DESCRIPTION OF ILLUSTRATIVE EMBODIMENTS

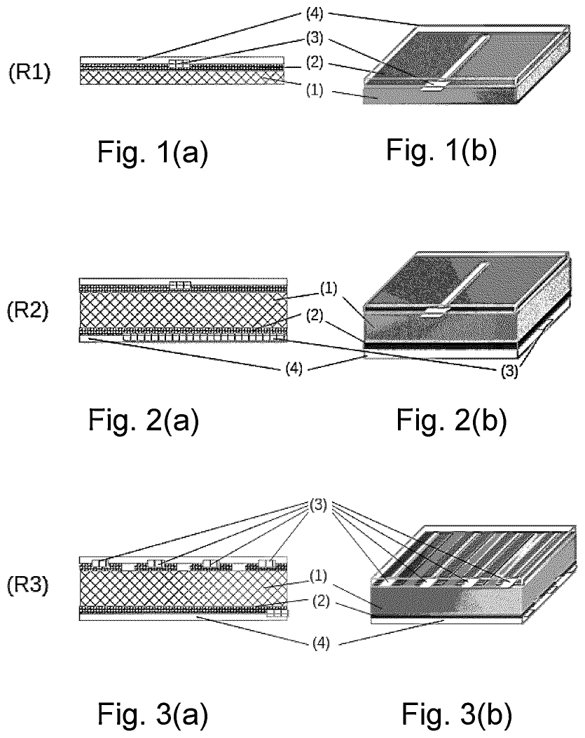

In a first aspect of the present invention, an electrically functional cellulose-based sheet is provided, comprising a cellulose-based substrate layer comprising conductive microparticles and comprising a top surface and a bottom surface, wherein one or both of the top surface or bottom surface is partially or fully covered with a binder layer comprising conductive particles. Referring first to FIG. 1, as well as FIGS. 2-6, the electrically functional cellulose-based sheet will be described.

The cellulose-based substrate layer 1 (also referred to as a cellulose skeleton in the present application) shown for example in FIG. 1 can be a conventional paper loaded with conductive microparticles instead of conventional paper making pigments such as clay. This cellulose-based substrate layer can then act as a resistive barrier, with its volume resistance, piezoresistive properties, and viscoelasticity depending on the cellulose-based substrate's thickness, roughness, and porosity.

The cellulose-based substrate layer substrate can comprise conventional cellulose-based substrates as would be understood by the person of skill in the art for (for example, paper typically used to make electrically functional papers) that have been loaded with conductive microparticles.

The conductive microparticles can be loaded into the cellulose-based substrate layer by mixing in said conductive microparticles with a fiber pulp that will be used to make the cellulose-based substrate layer.

Specific chemical additives called retention aids in papermaking are used to help retaining the finest microparticles in the paper. These chemicals are most often a combination of ionic charged polymers to generated chemical bonding between elements of opposed charges, such as cationic starch on anionic cellulose fibers and anionic particles or else another anionic polymer such as to bridge cationic particles with other cationic particles. Low or non-charged particles retention can also be increased with addition of long chain polymers also called resins that must provide a mechanical bonding and agglomeration of the fines particles and improve retention, while maintaining a uniform distribution of the particles and agglomerates sizes.

The choice for these additives additions is usually made in a lab prior to any new production involving new cellulose fibers or new particles. Initial patching and bonding strategy referenced in papermaking literatures enable to test various mixing sequences and lab-sheets production leading to wet-end chemistry recipes for the paper production.

A wet-end chemistry recipe provides the timing, order, amount and shear forces levels involved to mix the various retention aids with the cellulose fiber and the functional microparticles in water at given solids concentrations.

The recipe may also include the addition of retention aids and microparticles to be added as liquids on the paper machine during the paper formation, especially when injected with used water in a closed-circuit, and so as to regulate the targeted paper pulp content.

The recipe may also include the addition of other conventional additives in paper-making such as dispersants and flocculants to optimise the paper formation, anti-sceptic agents to control the fibers biodegradability, or else plasticizers, sizing and wet-resistant agents to reinforce the mechanical properties of the paper and its durability.

An optimised recipe is slightly different from each other for any new type of solid addition, and it also depends on the type, quality and content of water used. Thus, it is not valuable to provide too much more guided directions except:
added chemicals concentrations should remain low to favor optimised paper formation and lower pollution risks. Concentrations levels are typically as low as below 1% in weight of the paper solid content and combinations of up to 3 to 5 chemicals are often exploited to produce standard papers with a total concentration of additives that can go beyond 10% in weight of the paper solids content;
mixing order, timing and shear force levels are strategic and critical, to be based on classic theoretic patching and bridging schemes with empirical refinement with the goal for reaching the best compromise between retention levels and paper uniformity.

Retention is critical for costs and water pollution management and should be as high as possible as lost particles flows away with water. However, higher retention leads to lower paper uniformity, and so, only 70-90% of solid particles in pulp are usually retained in the paper.

Water consumption and treatment is also critical for costs and water pollution. Paper machines can work with closed and/or open water circuits. Open circuits consume much more water but it enables better and faster productions. Closed circuits always use the same used water that is constantly filtered and reinjected in the pulp, which considerably decreases the water needed for production. However, this addition of this “used water” with varying levels of particles also considerably increases the difficulties for obtaining a regular quality production and requires high-level automated machines to regulate this looping process.

An optimised paper must be as uniform and durable as possible while remaining remain recyclable; chemicals must not prevent it to be repulpable, and then fibers an particles can efficiently be reseparated by centrifugation and reused.

The conductive microparticles loaded into the cellulose-based substrate layer 1 are micron sized and can be conductive carbon solids, metal oxides or electrically functional polymers and specific materials such as phosphor (depending on the intended use of the electrically functional cellulose-based sheet. In preferred embodiments, conductive microparticles are carbon-based particles, more preferably a carbon-based pigment, even more preferably carbon black. In preferred embodiments, the weight ratio of the conductive microparticles to the fibers of the cellulose-based substrate layer range from 1:99 to 30:70, resulting in a passive or conducting resistance as described by IEC Norms 61340-5-3:2022), allowing the cellulose-based substrate layer to act as a resistive barrier.

By loading the cellulose-based substrate layer with the above-defined conductive microparticles, said layer can form part of an eventual circuit (as opposed to using, for example, conventional papers, which are dielectric and are generally used to support electronic circuits). In addition, by using said conductive microparticles, the cellulose-based substrate layer can be manufactured using conventional paper making processes and machines (as opposed to if nanoparticles were used, which would likely damage conventional machinery).

Depending on the properties of the conductive microparticles and the amount present in the cellulose-based substrate layer, the properties of the cellulose-based substrate layer will change. For example, more conductive microparticles will generally result in a more conductive and less resistive cellulose-based substrate layer, whereas fewer conductive microparticles will result in a more resistive cellulose-based substrate layer 1.

The papermaking process also enables to control and adjust the final porosity and roughness of the paper substrate layer 1 or by adding a surface sizing or coating of starch-based polymers filling the paper substrate roughness during its fabrication, which is directly related to its mechanical properties and to its cost-effective printability as the ink consumption increases with the printed support roughness and the prints quality depends on the mechanical properties of the printed support, and so a lower porosity is favored to increase the paper substrate elasticity under compression, and a low roughness is favored for the paper sides to be printed.

As mentioned, this cellulose-based substrate layer 1 is fully or partially covered by a thin binder layer 2 (also referred to as a binder coating in the present application) as shown in FIGS. 1 to 3, which can be added, for example, during paper production with, for example, conventional paper making machines with a coating section, or through secondary steps such as manual or industrial printing processes. The binder layer is electrically functional and can be made of conventional binder layers known in the art (e.g., those obtained using carbon inks). In preferred embodiments, the binder layer 2 is an organic-based binder layer such as starch-based binder or cellulose derivates like CMC (Carboxy-Methyl-Cellulose) that are soluble in water or another printing solvent and are more biodegradable and compostable than standard oil-based industrials binders such as Acrylic or Acetate polymers (PVAc or polyacrylamides).

As for cellulose-based paper filled with particles and chemicals, a printed layer can also be repulped but it will not decompose as well as would cellulose and it is harder to recycle the particles from an ink composite, especially with highly durable synthetic-plastics and oil-based industrial plasticizers. Thus, and unless aiming for the development of highly durable products, the polymer binders we use in most consumer products should preferably be organic based and thermo-plastics that can enable to unbind from the particles under recycling process and that are biodegradable or compostable.

This binder layer 2, which can be coated or printed onto the cellulose-based substrate layer, can then either act as an insulator, a spacer, or an electrode, depending on its thickness and on the type, distribution, and quantity of conductive particles loaded therein. As mentioned, the binder layer 2 can be applied either on one or both the top and bottom surfaces of the cellulose-based substrate layer 1 and can have the same or different properties of the cellulose-based substrate layer.

In general, though, due to the nature of the cellulose-based substrate layer (being a generally fibrous material), said layer will generally not be able to contain as many conductive particles as the binder layer. In preferred embodiments, the binder layer has a conducting resistance that is at least 100 times less resistive than that of the cellulose-based substrate layer and acts as an electrode in regard to the cellulose-based substrate layer.

The binder layer can be partially applied over the surface of one or both of the top and bottom surface of the cellulose-based substrate layer 1, such as in the form of linear bands, which would act, in the case of resistive components, as electrode bands.

As mentioned, each binder layer 2 contains conductive particles, which, for the binder layer, are preferably micron sized or smaller carbon-based particles, or other conductive elements, such as graphite, metal oxides or conductive polymers. In more preferred embodiments, the conductive particles are nano-scaled carbon-black pigments.

In preferred embodiments, the weight ratio of the conductive particles (preferably pigments) to the binder ranges from 5:95 to 80:20, resulting in a conducting resistance that preferably at least 100 times less resistive than that of the cellulose-based substrate layer and acts as an electrode in regard to the cellulose-based substrate layer.

As with the cellulose-based substrate layer 1, depending on the properties of the conductive microparticles and the amount present in each binder layer, the properties of each binder layer will change. For example, more conductive microparticles will generally result in a more conductive and less resistive each binder layer.

Further, the degree of electrical conductivity of each binder coating or the cellulose-based skeleton is mainly related to the size of the conductive microparticles and conductive particles (e.g., pigments), the amount thereof, and their distribution in the binder coating(s) or the cellulose-based skeleton. One can then electrically produce layers with conductivity ranging from below 10 Mohms (e.g., if no or little (<5% solids) conductive microparticles or conductive particles are used), down to below 1 Kohm (e.g., with high loads of adequate conductive microparticles (>20% Solids) or conductive particles distributions), when testing industrial carbon particles used for our industrial pilot productions in lab and under IEC 61340-5-3{ed3.0}b and normative reference for the measurement of volume resistance, with carbon-loaded sheets of various thicknesses from 60 to 300 microns compressed between two normalised electrodes.

Each binder layer 2 can comprise a single coating, or multiple coatings, wherein each coating can itself be its own binder layer as defined above, and the various coatings can be the same or different from each other (e.g., they can be made of different materials, and contain different conductive particles).

As mentioned, the binder layer(s) 2 fully cover the top and/or bottom surface of the the cellulose-based substrate layer or only partially so as to generate functional areas. The binder layer 2 can be applied through papermaking processes (using conventional paper machines) and printing processes, as well as through successive layers of varying conductivity, each having specific and complementary electrical properties.

The electrically functional cellulose-based sheet may also further comprise electrical connectors and connection lines such as metal electrodes and solderable pads 3, as shown for example in FIGS. 1 to 3, over each binder layer 2. As mentioned, each binder layer 2 and the connection lines 3 can be added onto the cellulose-based substrate layer 1 directly using a paper machine with a coating section and a coating slurry of starch containing other specific functional particles, or they can be printed later, on one or both sides of the cellulose-based substrate layer 1 with conventional electronic printing processes.

The electrically functional cellulose-based sheet may also further comprise external layers or encapsulators 4 acting as an electrical insulator, and as protection to other external strains. Such an external layer 4 can be applied over the other layers (the binder layer 2 and the cellulose-based substrate layer 1 as a final coated or printed layer, or it can be laminated on and be a dielectric, shear resistant and/or waterproof layer so as to encapsulate and protect the electro-functional assembly from strain, temperature and humidity, and so as to adapt the resulting electrical component's durability in function of its usage versus its recyclability (see, for example, FIG. 1).

The role of the layer 4 is to protect the inside from external strains for the product life-time. It preferably contains no particles and is made of a single type of easily recyclable material once delaminated.

In preferred embodiments with short life-time and a minimal protection required, the external layer 4 is made of a material such as paper packaging (e.g. Kraft paper) and the whole product will remain paper-based and directly recyclable.

In preferred embodiments with longer life-time and higher protection required, the external layer 4 of the electrically functional cellulose-based sheet is made of plastic, such as PET, while the rest of the electrically functional cellulose-based sheet is free of plastic and the whole being easily recyclable one papers and plastics are delaminated; this way, a minimal amount of plastic is used while the product while both the product durability and recyclability are being optimized.

The electrically functional cellulose-based sheet of the present invention can be used for the production of various types of electronic components, such as force, position or flexion sensors (or other electronic components) and combinations thereof. This electrically functional cellulose-based sheet has a complex structure of at least two functional layers (the cellulose-based substrate layer 1 and at least one binder layer 2) which can act as an insulator, resistive barrier, or electrode, depending on their electrical volume conductivity, and is mainly made of cellulose fibres enclosing conductive microparticles, such as carbon-based particles or other electrically functional microparticles, preferably with minimal amounts or chemical binders to reinforce the substrate.

In preferred embodiments, the electrically functional cellulose-based sheet comprises no more than 1 w/w % of polymer plastics, and is preferably free of plastic material.

### Double Coated or Single Coated Electrically Functional Cellulose-Based Sheet

Depending on whether only one or both of the top or bottom surfaces of the cellulose-based substrate layer 1 are covered with the binder layer 2, two different kinds of electrically functional cellulose-based sheets can be obtained. If both the top and bottom surfaces of the cellulose-based substrate layer are covered (preferably fully covered) with the binder layer, then a double coated electrically functional cellulose-based sheet is obtained (see FIG. 2, for example), where both binder layers preferably act as electrodes. In embodiments, this double coated electrically functional cellulose-based sheet can be a ready-to-use force sensing material that, in embodiments, need only be operatively connected to an electronic device via both binder layers to provide a signal response to force variations applied onto its surface. In this case, all the layers 1 and 2 are bonded together with no air gap in between.

Conversely, if only one of the top or bottom surfaces of the cellulose-based substrate layer 1 is covered (preferably fully covered) with the binder layer 2, a single coated electrically functional cellulose-based sheet will be obtained (see FIG. 1, for example), where the coating can act as an electrode and which can be used as a component in the production of various types of sensors, such as force, flexion, position, and arrays of sensors (or other electronic components). In this case, this is done by assembling at least two of three single coated electrically functional cellulose-based sheet together by different manners and with example described below. The sheets can have their surfaces fully or locally bonded together. In preferred embodiments, the sheets are not bonded and encapsulated together leaving an air gap between their contact surfaces. This air gap stabilises and improves the default signal response and sensitivity of the sensors produced for small compression levels below 1 kg/cm².

These two products (double coated electrically functional cellulose-based sheets and single coated electrically functional cellulose-based sheets) can be designed to be scalable, customizable and to be built either manually or industrially. These electrically functional cellulose-based sheets, preferably the double coated electrically functional cellulose-based sheet, can further include metal electrodes. The binder layer 2 (one or both) can also be striated to generate conductive lines (for a matrix design), or any type of functional pattern. The design of such cellulose-based force or flexion sensors can be provided as a single element or as a matrix of sensitive areas, as would be understood by a person of skill in the art. Other sensors (1D-2D position sensors) can also be produced through conventional means using the electrically functional cellulose-based sheets of the present invention, as well as other types of electronic components.

In embodiments, the resulting resistance range of such sensors can be defined and adapted to micro-controller requirements and can vary between 1 Kohm and 10 Mohms for force sensors, depending on the conductive microparticle (preferably carbon-black) content in the cellulose-based substrate layer 1 and conductive particle (preferably carbon-black) content in the binder layer 2, as well as the load applied.

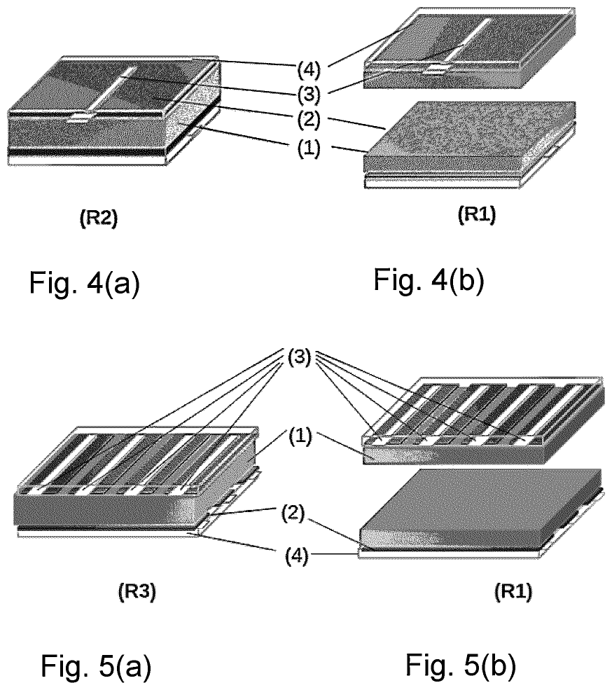

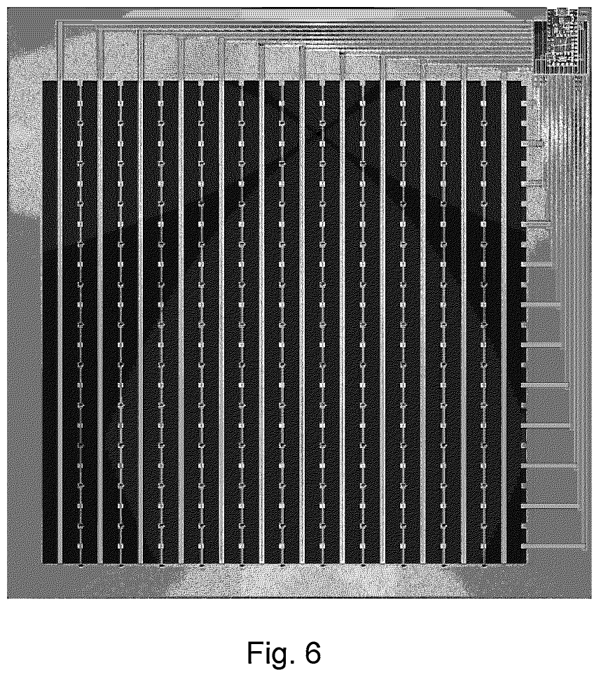

In embodiments (see, for Example, FIG. 4(b)), a combination of two separate single coated electrically functional cellulose-based sheets, facing each other with the binder layers 2 not in direct contact with each other, can be assembled to create a sheet assembly similar to a double coated electrically functional cellulose-based sheet. In embodiments (see, for example, FIG. 5(b)), each binder layer 2 is in the form of linear electrode bands, preferably with one sheet rotated 90 degrees in comparison with the other; with such a configuration, the resulting sheet assembly comprises a ready to connect array of rows and columns acting as a multi-touch surface (see FIGS. 5(b) and 6, for example). When compared to a double coated electrically functional cellulose-based sheet, the two single coated electrically functional cellulose-based sheets are not bound to each other, meaning they can still move with respect to each other, which makes the resulting sensor more sensitive.

FIG. 1 and FIG. 2 respectively show both single (R1) and double coated (R2) electrically functional cellulose-based sheets, which can be used for various applications depending on the conductive microparticle contents of the cellulose skeleton or substrate layer 1 and the conductive particle contents of the binder coating or binder layer 2. Thus, each of the binder layer(s) 2 and the cellulose-based layer 1 can act as an insulator, a resistor or a conductor depending on the electronic component to be produced.

For the fabrication of touch sensors, the cellulose skeleton or substrate layer 1 will mainly act as a resistive barrier and each binder layer 2 as a conductive electrode, as seen in FIGS. 4 and 5. A double coated electrically functional cellulose-based sheet (with the cellulose-based substrate layer being fully coated on both top and bottom surfaces) can act as a force sensitive resistor when connected on the surface of each side as shown with (R2) in FIG. 2. A double coated electrically functional cellulose-based sheet with coating patterns on both surfaces can act as a force sensitive surface of resistors when connected on the surface of each conductive pattern. For instance, the coating of horizontal conductive lines on one side (e.g., the top surface of the cellulose-based substrate layer 1), and vertical conductive lines on the other side (e.g., the bottom surface of the cellulose-based substrate layer 1) will generate a multi-touch sensitive array of independent force sensitive resistors, as shown in FIG. 5 (R3) and FIG. 6.

A single coated electrically functional cellulose-based sheet (with the cellulose-based substrate layer being coated only on one of the top and bottom surfaces) with a resistive cellulose skeleton and a conductive binder layer can be used as a raw material for the production of force sensing resistors as shown in FIGS. 1 and 4(b) with (R1) and arrays of independent force sensing areas as shown in FIG. 5 (b) for (R1), as well as for the production of position sensors as used in resistive touch screens or touch pads or the production of flexion sensors such as the ones used in virtual reality gloves. An example of the production of a 12*12 array of 144 independent sensitive cells is shown in FIG. 6 as an example of custom patterns and connection designs to a microcontroller using the method described in the present application.

FIG. 6 shows an example of functional multi-touch force sensing device composed of electrically functional cellulose-based R3 sheets on a dielectric support and wired to additional electronic diodes and microcontroller board components.

Each Figure also shows connection lines 3 onto the electrode binder coating and an insulating external layer 4 to solidify and protect the assembly as described above.

As mentioned, depending on the intended application of the electrically functional cellulose-based sheet, the properties of the electrically functional particles loaded into the cellulose-based substrate layer and the binder coating(s) can be varied. For example, when designed to produce resistive force sensors or other components, the cellulose-based substrate layer can be filled with carbon pigments or other electrically resistive particles acting as a resistive or piezoresistive material, while electrically conducing particles can be used in the binder coating(s) acting as electrodes, such that the electrical surface resistance of the binder coating(s) is at least 100 times more conductive than that of the cellulose-based substrate layer, such that, with a double coated electrically functional cellulose-based sheet, the electrical resistance between the 2 electrode layers will decrease when the electrically functional cellulose-based sheet is compressed, with a sensitivity that is a function of the substrate elasticity.

The main advantages of the electrically functional cellulose-based sheet of the present invention, and method of production thereof (defined below), can include the following: (1) It allows inexpensive, simple and fast production of sensors (or other electronic components); (2) It produces recyclable and non-polluting sensors (or other electronic components); (3) The produced sensors (or other electronic components) are scalable and customizable, and unlimited in terms of sizes and shapes; (4) The sensitive material could be offered as a series of sensors dedicated to any commercial Analog to Digital Converters; and (5) One can combine any type of cellulose-based or recyclable materials to be used as embedder, support, protection and haptic foam, etc., to offer a complete recyclable sensor (or other electronic components).

### Method of Producing Electrically Functional Cellulose-Based Sheet

In a second aspect of the present invention, a method of producing an electrically functional cellulose-based sheet is provided, said method comprising the step of:
partially or fully covering one or both of a top surface or a bottom surface of a cellulose-based substrate layer 1 comprising conductive microparticles with a binder layer 2 comprising conductive particles.

The method of the present invention can further provide a step of producing the cellulose-based substrate layer comprising conductive microparticles. As mentioned, this can be done by mixing in said conductive microparticles with a fiber pulp that can then be made into cellulose-based substrate layer using conventional paper making means (e.g. a paper making machine). This mixing is preferably performed in water in order to help ensure that the mixture is uniform; however, in more preferred embodiments, the amount of water used is just enough to create a uniform mixture, since that is better for the environment. In preferred embodiments, the weight ratio of the conductive microparticles to the fibers of the cellulose-based substrate layer range from 1:99 to 30:70.

The method can further comprise adding electrical connectors and connection lines such as metal electrodes and solderable pads 3 to the electrically functional cellulose-based sheet.

The method can further comprise adding external layers or encapsulators 4 to the electrically functional cellulose-based sheet.

The terms used in the present section of the application for the method have the same meaning as in the previous section (e.g., electrically functional cellulose-based sheet; cellulose-based substrate layer; conductive microparticles; binder layer; conductive particles; etc.).

The steps involved in the method of the present invention can be based on and be complementary to conventionally used industrial processes in the fields of papermaking, printing and converting, thereby allowing for more cost-effective production of electronic force sensors and other electronic components through existing industries.

As mentioned in the previous section, the method of producing the Electrically Functional cellulose-based sheet of the present invention can result in an electrically functional thin and complex specialty substrate that exploits at least two (2) functional layers of a sensitive cellulose-based skeleton fully or partially coated with a binder layer loaded with a specific amount of conductive particles, such as nano-scaled carbon-black pigments (or other conductive elements, such as graphite, metal oxides or conductive polymers), to form a conductive electrode over said top and/or bottom surface.

This covering step can be done by coating with a slurry of starch/carbon black coating or by using printed processes. As mentioned, this covering step can be performed on either one side (case B) or on both sides (case A) of the cellulose-based skeleton. The binder layer can also help reinforce the sheet against shear forces and decrease its moisture sensitivity. In both cases (case A and case B), in preferred embodiments, the design can include metal electrodes, and can be scalable, customizable, and can be built either manually or industrially.

In case A (Conductive binder coating on both top and bottom surface of the cellulose-based layer 1, which can be used for the production of a ready to connect force sensitive material), the electrically functional complex substrate (i.e., the cellulose-based substrate layer 1) can act as a piezoresistive material in thickness compression with the binder layers 2 (which can be coated or printed on), which can act as electrodes, with the resulting electrically functional cellulose-based sheet forming a force sensitive surface. The binder coating can be generated with varying amounts and distributions of conductive particles such that the sheet is, for instance, horizontally striated on one side and vertically striated on the other side so as to generate an array of sensitive force cells, also called a matrix design (see R3 in FIG. 3, for example), or else to generate any pattern of custom conductive and non-conductive areas.

Moreover, additional printing processes can be used to print conductive paths for electronic connections onto each electrode binder layer or areas of the complex substrate, and alternative metal-based adhesives of clipping systems can be used on each electrode binder layer to connect the resulting sensors to electronic devices (see FIG. 6).

In case B (Conductive binder coating on only one of the top or bottom surface of the cellulose-based layer 1, which can be used for the production of a convertible material to be used for the production of various types of sensors and patterns or arrays of sensors), two different two-layered (one sided) electrically functional cellulose-based sheets can be placed facing each other and assembled together, as shown for example in FIGS. 4b and 5b, with each sheet's corresponding binder layer 2 (which can be coated or printed on), which function as electrode surfaces, turned to the “exterior” (e.g., the binder layer of the lower electrically functional cellulose-based sheet faces downward and the binder layer of the higher electrically functional cellulose-based sheet faces upward, as shown in FIG. 4(b)), such that the binder layers 2 of each electrically functional cellulose-based sheet are not in contact with each other, thereby forming a force sensitive surface where a variable electrical resistance can be read when connecting the binder layers that decreases when compressing the assembly.

In embodiments, each binder coating (binder layer 2) can be generated such that the resulting electrically functional cellulose-based sheets are striated for a matrix design, to generate bands of conductive and non-conductive areas. The combination of two separate striated electrically functional cellulose-based sheets facing each other with the conductive bands on the exterior and one electrically functional cellulose-based sheet rotated 90 degrees in comparison with the other easily generates a matrix of lines and columns that just needs to be connected on one end of each conductive band to be able to acquire multiple measurements corresponding to the force applied at each cross-section of two conductive bands (see FIG. 5, for example).

Moreover, as mentioned, additional printing processes can be used to print conductive paths for electronic connections onto each electrode binder layer 2, and alternative metal-based adhesives of clipping systems can be used on the electrode layer to connect the resulting electrically functional cellulose-based sheet (e.g., sensors) to electronic devices.

Furthermore, and according to a preferred embodiment, the resulting electrically functional cellulose-based sheet, which can be used as a sensor (or other electronic component) can optionally be reinforced using an insulation cover 4 such as by being sprayed with varnish, or by being laminated between two thin insulation sheets such as PET film. The electrically functional cellulose-based sheet can comprise additional passive/dielectric/conductive layers if the electro-functional assembly inside the electrically functional cellulose-based sheet needs to be protected from anti-static discharge and electro-magnetic fields.

In preferred embodiments of the method of the present invention, the raw materials used, such as cellulose or carbon black, are renewable, locally available, and/or recycled resources, such that the resulting electronic components can be produced and recycled locally within existing facilities, where the additional functional elements mixed in the substrate layer 1 and the additional layers 2, 3, 4 can be separated from the cellulose and other massive elements through conventional de-inking or centrifugation processes used for paper recycling.

The method of the present invention can provide more simplicity for the fabrication of sensors and can allow for sped up production. Other sensors (1D-2D position sensors) can also be produced through conventional methods using the electrically functional cellulose-based sheet of the present invention. The resulting resistance range of the sensors made using the electrically functional cellulose-based sheet of the present invention can be defined and adapted to micro controller requirements, and can vary between 1 Kohm and 10 Mohms for force sensors, depending on the conductive microparticle (e.g., carbon-black) and conductive particle (e.g., carbon-black) content and the load applied. The electrically functional cellulose-based sheets of the present invention, and the method of production thereof, can also enable the production of a variety of other electronic compounds, sensors and transducers such as resistors, capacitors, position or flexion sensors, heat and moisture sensors, or else piezoelectric and heat or energy transducers, depending on the contents of each binder layers' conductive particles and the cellulose-based substrate layer's conductive microparticles (e.g., pigments), and the way they are converted and connected.

### Possible Component Production Variations

In another aspect of the invention, there is provided an electric component, preferably a sensor, comprising the electrically functional cellulose-based sheet of the present invention. Other examples of electronic components are described in the previous sections.

A variety of other types of components can be produced depending on the functionality provided by the conductive microparticles of the cellulose-based substrate layer and conductive particles of each binder layer. Basically, most electronic components comprising a substrate layer (the cellulose-based substrate layer) embedded between or around conducting electrode layers (the binder layer(s)) can be produced through the method of the present invention. What follows is a non-exhaustive list of possible electronic components and the preferred conditions therefor:
insulated ribbon wires: highly conductive skeleton and insulating binder coating.
insulated and shielded ribbon: highly conductive cellulose skeleton and a insulating/shielding binder coating.
capacitors and capacitive surfaces: insulating cellulose skeleton and conductive binder coating.
piezoelectric elements and inductors, and RFID antennas: highly resistive cellulose skeleton and specific patterns inside the conductive binder layers.
semi-conductors, OLEDs transistors: can be made using known techniques in the art and appropriate functional particles.
Batteries and super capacitors: can be made using known techniques in the art and appropriate functional particles.
electromagnetic components sensors and actuators: can be made using known techniques in the art and appropriate functional particles.

In embodiments, the electrically functional cellulose-based sheet of the present invention (comprising a cellulase-based substrate layer and a binder layer) can be added to a printed circuit board.

### Advantages of the Invention

In addition to the advantages discussed above, in embodiments, the electrically functional cellulose-based sheet of the present invention can present one or more of the following advantages:

The electrically functional cellulose-based sheet of the present invention can be used as a production component for FSRs, or other electronic components, made using inexpensive production methods, using, for example, cellulose paper and carbon-black pigments, which are environment-friendly and recyclable, therefore without using synthetic polymers.

The method of the present invention produces the above-defined electrically functional cellulose-based sheet. In addition, in embodiments, the method of the present invention can present one or more of the following advantages:

The method of the present invention can allow for the production of highly green and sustainable electronics. This is accomplished by:
The use of cellulose and organic substrates for, for example, the binder coating slurry or ink medium instead of conventional petroleum-based polymer substrates such as PCB or PEI for the whole sensor (except for connections) and not only for the middle sheet (“sensitive paper”, the cellulose-based substrate layer).
No use or minimal use of metal (e.g. Silver pigments) for the electrodes fabrication, by intelligent management of appropriate correspondence between the electrode layer (the binder layer) and “sensitive paper” layer (the cellulose-based substrate layer).

Minimal use of bioresistant bonding chemicals can allow for high shear resistance, waterproof properties, and control of the material biodegradability over time. This also can enable the provision of very inexpensive sensors of up to 1 square meter in size, or else a matrix of such sensors. Also, when requiring output sensor resistance of the order of Kohm, it is possible to produce the sensor without any metal for the sensitive area, which can enable the production of large and inexpensive sensitive materials to be placed in the ground, behind walls or in any place requiring contact detection.

All in all, the electrically functional cellulose-based sheets of the present invention can be designed to be inexpensive, simple and fast to produce, to be recyclable and therefore environment-friendly, and to be scalable and customizable.

As mentioned, when the conductive microparticles loaded into the cellulose-based substrate layer 1 are carbon or electrically resistive, it can enable the production of force sensors or other electrically resistive sensors or components that are scalable, customizable and unlimited in terms of sizes, shapes and assembly designs that can be created, and where the output resistance range of the resulting component or sensor will depend on the nature and the concentration of the resistive conductive microparticles in the cellulose-based substrate layer and in the conductive particles in each conducting binder layer 2 acting as an electrode, as well as on the assembly design and the position of the connection lines and connectors 3. This way, the same electrically functional cellulose-based sheet used to produce force sensors can be used for example as a flexion sensor if it is bent, or to produce a position sensor between 2 connected points over the same binder layer surface of a first sheet, and another one connected to read the position of pressure between the two points of the connected surface.

Depending on the nature of the conductive microparticles loaded into the cellulose-based substrate, or, for example, the inks used, the same production method can also enable the production of a variety of other electronic compounds, sensors and transducers. For example, dielectric clay, Kaolin or TiO2 pigments used in papermaking, resistors with carbon, graphite or conducting polymers such as PEDOT PSS, conductors with copper, silver, or graphene based conducting binder coating and inks, or even other functional elements such as piezoelectric, thermochromic, electro-chromic, magnetic, heat capacitive or else electrolytic additives can be added in the cellulose-based substrate (1). The binder layer(s) (2) can be adapted to produce anti-static materials, diodes, LEDs, transistors, batteries, heat and moisture sensors, piezoelectric and heat or energy transducers, depending on the conductive particles in said binder layers (preferably pigments), and depending on the way the electrically functional cellulose-based sheets are assembled, converted, and connected.

The scope of the claims should not be limited by the preferred embodiments set forth in the examples but should be given the broadest interpretation consistent with the description as a whole.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

1. An electrically functional cellulose-based sheet, comprising:
a cellulose-based substrate layer (1) comprising conductive microparticles and a top surface and a bottom surface, wherein one or both of the top surface or bottom surface is partially or fully covered with a binder layer (2) comprising conductive particles.

2. The electrically functional cellulose-based sheet of claim 1, wherein the cellulose-based substrate layer (1) is a conventional paper comprising the conductive microparticles; or wherein the conductive microparticles are loaded into the cellulose-based substrate layer (1) by mixing in said conductive microparticles with a fiber pulp that is used to make the cellulose-based substrate layer; or wherein the conductive microparticles are conductive carbon solids, metal oxides, or electrically functional polymers; or wherein the conductive microparticles are carbon-based particles or a carbon-based pigment, or carbon black.

3. (canceled)

4. (canceled)

5. (canceled)

6. (canceled)

7. The electrically functional cellulose-based sheet of claim 1, wherein each binder layer (2) is added during paper production with a conventional paper making machine with a coating section, or through secondary steps including manual or industrial printing processes.

8. (canceled)

9. (canceled)

10. The electrically functional cellulose-based sheet of any one of claim 1, wherein each binder layer (2) has a conducting resistance that is at least 100 times less resistive than that of the cellulose-based substrate layer (1) and acts as an electrode in regard to the cellulose-based substrate layer (1).

11. The electrically functional cellulose-based sheet of any one of claim 1, wherein each binder layer (2) is only partially applied over the surface of one or both of the top and bottom surface of the cellulose-based substrate layer (1) so that one or both of the top surface or bottom surface is only partially covered with the binder layer (2); or wherein the conductive particles in each binder layer (2) are micron sized or smaller carbon-based particles, or other conductive elements, including graphite, metal oxides or conductive polymers, preferably in the form of linear bands, which more preferably act as electrode bands.

12. (canceled)

13. (canceled)

14. (canceled)

15. (canceled)

16. (canceled)

17. The electrically functional cellulose-based sheet of claim 1, wherein each binder layer (2) comprises a single coating or multiple coatings.

18. (canceled)

19. The electrically functional cellulose-based sheet of claim 1, further comprising electrical connectors and connection lines such as metal electrodes and solderable pads (3).

20. The electrically functional cellulose-based sheet of claim 1, further comprising an external layer or encapsulator (4).

21. The electrically functional cellulose-based sheet of claim 20, wherein the external layer (4) is applied over each binder layer (2) and the cellulose-based substrate layer (1) as a final coated or printed layer, or it is laminated on.

22. The electrically functional cellulose-based sheet of claim 20, wherein the external layer (4) is a dielectric, shear resistant and/or waterproof layer.

23. (canceled)

24. (canceled)

25. The electrically functional cellulose-based sheet of any one of claim 1 for use in the production of various types of force, position or flexion sensors, other electronic components, or combinations thereof; or wherein one or both binder layers (2) are striated to generate conductive lines or any type of functional pattern; or wherein the top and bottom surfaces of the cellulose-based substrate layer (1) are partially or fully covered with the binder layer (2).

26. (canceled)

27. (canceled)

28. The electrically functional cellulose-based sheet of claim 1, wherein only one of the top or bottom surfaces of the cellulose-based substrate layer (1) is partially or fully covered with the binder layer (2), thereby producing a single coated functional cellulose-based sheet.

29. An assembly comprising two single coated functional cellulose-based sheets as defined in claim 28 facing each other with the binder layers (2) at opposite ends of the assembly

30. The assembly of claim 29, wherein each binder layer (2) is in the form of linear electrode bands, or wherein one sheet is rotated 90 degrees in comparison with the other.

31. Method of producing the electrically functional cellulose-based sheet as defined in claim 1, the method comprising:
a) partially or fully covering one or both of a top surface or a bottom surface of a cellulose-based substrate layer (1) comprising conductive microparticles with a binder layer (2) comprising conductive particles.

32. The method of claim 31, further comprising a step of producing the cellulose-based substrate layer (1) comprising conductive microparticles, by mixing in said conductive microparticles with a fiber pulp that is then made into the cellulose-based substrate layer (1); or further comprising adding electrical connectors and connection lines including metal electrodes and solderable pads (3) to the electrically functional cellulose-based sheet; or further comprising adding external layers or encapsulators (4) to the electrically functional cellulose-based sheet.

33. (canceled)

34. (canceled)

35. (canceled)

36. The method of any one of claim 31, wherein the step a) is performed on one of the top surface or the bottom surface of the cellulose-based substrate layer (1), thereby producing a single coated functional cellulose-based sheet; or wherein the step a) is performed on both of the top surface and the bottom surface of the cellulose-based substrate layer (1).

37. (canceled)

38. The method of claim 36, wherein the step a) is performed on both of the top surface and the bottom surface of the cellulose-based substrate layer (1) and wherein one binder layer is horizontally striated and another binder layer (2) is vertically striated so as to generate an a matrix design.

39. The method of claim 36, wherein the step a) is performed on one of the top surface or the bottom surface of the cellulose-based substrate layer (1), thereby producing a single coated functional cellulose-based sheet, and further comprising a step of combining two single coated functional cellulose-based sheets such that the binder layers face away from the other, such that the binder layers (2) of each electrically functional cellulose-based sheet are not in contact with each other when the two single coated functional cellulose-based sheets are combined

40. (canceled)

41. (canceled)

42. An electrical component comprising the electrically functional cellulose-based sheet as defined in claim 1.

43. (canceled)
